(19) United States
(12) Patent Application Publication
(10) Pub. No.: US 2025/0302011 A1
(43) Pub. Date: Oct. 2, 2025

(54) Solar-Powered Chicken Coop Door

(71) Applicant: Shenzhen Ruichaoteng Technology Co., Ltd., Shenzhen (CN)

(72) Inventor: Jianhui Li, Shenzhen (CN)

(21) Appl. No.: 19/018,954

(22) Filed: Jan. 13, 2025

(30) Foreign Application Priority Data
Mar. 29, 2024 (CN) 2024206358777

(51) Int. Cl. A01K 31/02

(52) U.S. Cl. CPC A01K 31/02

(57) ABSTRACT

The present application reveals Solar-powered Chicken Coop Door designed for poultry farming. It comprises a rolling gate, an aluminum alloy casing, a solar panel, a battery, and a motor. The solar panel supplies energy to the gate's switch, while the battery and motor are housed within the aluminum casing. The setup includes a battery compartment and motor compartment, along with a central rotation shaft embedded in the aluminum housing. This invention uses solar power to automate the door, reducing manual intervention. Additionally, ultrasonic waves and blinking lights deter animals without harming humans, enhancing the chicken coop's protection and significantly boosting farmers' productivity.

### TECHNICAL FIELD

The present application relates to the technical field of poultry farming, and specifically relates to a solar-powered chicken coop door.

### BACKGROUND OF THE PRESENT INVENTION

Poultry farming has been in China for more than 5,000 years. Since the reform and opening up for more than 30 years, China's poultry industry has achieved rapid development. Poultry breeding and egg production have remained the first in the world for many consecutive years, and poultry meat production is the second in the world. At this stage, we are experiencing a transition period: from simple production methods, low production efficiency and production levels to a modern breeding model.

Existing chicken coop doors generally have only a single switch gate to control the entry and exit of chickens. There is no protective equipment outside the chicken coop. When animals such as cats and dogs enter the chicken coop from a single switch gate, they will cause damage to the chickens in the chicken coop, thus causing certain losses to farmers.

### SUMMARY OF PRESENT INVENTION

To this end, this application provides a solar-powered chicken coop door, which can drive away nearby cats, dogs, mice and other animals that are sensitive to ultrasonic waves and light after the chickens return to the cage. This ultrasonic wave can effectively protect the chickens from harm. This ultrasonic wave is harmless to people, so as to solve the problem that the existing chicken coop doors generally only have a single switch gate to control the chickens' entry and exit, and the chicken coop does not have protective equipment. When animals such as cats and dogs enter the chicken coop from a single switch gate, they will cause damage to the chickens in the chicken coop, thus causing certain losses to the farmers.

In order to achieve the above purposes, the present application provides the following technical solution: a solar chicken house door includes:
Rolling gate, the top of which is provided with an aluminum alloy casing;
Solar panel, the bottom of the solar panel is provided with solar panel housing, the solar panel is used to provide energy for the switch of the rolling gate;
Battery, the battery is disposed on the inner side of the aluminum alloy housing, a battery compartment housing is disposed on the outer side of the battery, and a battery compartment cover is disposed on the one side of the battery compartment housing;
Motor, the motor is arranged on the other side of the aluminum alloy housing, a motor bin housing is arranged on the outside of the motor, and a motor bin cover is arranged on one side of the motor bin housing.

Preferably, the aluminum alloy housing is internally embedded with a central rotation shaft, and the front side of the central rotation shaft is provided with a clamping gate steel bar.

Preferably, the aluminum alloy housing is internally embedded with a control bin rear cover, the front side of the control bin rear cover is provided with a PCB motherboard, the rear cover of the control bin is internally embedded with two ultrasonic horns, and the two ultrasonic horns are respectively arranged on both sides of the PCB motherboard.

Preferably, the front side of the back cover of the control bin is provided with a control bin housing, and a display screen is embedded inside the control bin housing, and the display screen is arranged on the front side of the PCB motherboard and connected to the PCB motherboard.

Preferably, a flashlight lens and an infrared sensing cover are embedded inside the control bin housing, the flashlight lens and the infrared sensing cover are arranged on the top of the display screen, and a PVC sheet with a function button is arranged on the front side of the control bin housing.

Preferably, the motor compartment housing and the bottom of the battery compartment housing are provided with a right rolling gate guide bracket and a left rolling gate guide bracket.

Preferably, an aluminum strip is disposed at the bottom of the rolling gate, and the aluminum strip is disposed between the right rolling gate guide bracket and the left rolling gate guide bracket.

Preferably, the bottom of the solar panel housing is provided with a solar panel bottom cover, and the bottom of the solar panel housing is provided with a ground socket swing adjustment part.

Preferably, the bottom of the ground socket swing adjustment part is provided with a ground insertion middle part, and the bottom of the ground insertion middle part is provided with a ground insertion tip member.

Preferably, a DC head interface line connecting the main body is provided on one side of the solar panel bottom cover.

The beneficial effects of this application are:

Through two ultrasonic horns and two flashing lights, it is possible to drive away the cats, dogs, mice, and other animals lurking nearby after the chickens return to the cage, which can effectively protect the chickens from harm. This ultrasonic wave is harmless to the person. In order to solve the problem, the existing chicken coop doors generally only have a single switch gate to control the chickens' entry and exit. There is no protective equipment outside the chicken coop. When animals such as cats and dogs enter the chicken coop from a single switch gate, they will cause damage to the chickens in the chicken coop, thus causing certain losses to the farmers. This application greatly improves the protection effect on the chicken coop. At the same time, the ultrasonic waves and flashing lights set in this device will not cause harm to the person while driving away the animals, thus the production benefits of farmers will be greatly improved.

### BRIEF DESCRIPTION OF THE DRAWINGS

In order to clarify more clearly the embodiment of the present application or the technical solutions in the prior art, a brief description of the drawings required to be used in the description of the embodiment or prior art is presented below. Obviously, the drawings in the following description are merely exemplary, and for those of ordinary skill in the art, other implementation drawings may also be obtained in accordance with the provided drawings without paying for creative labor.

The structures, proportions, sizes, etc. described in this specification are only used to cooperate with the contents disclosed in the specification for those familiar with this technology to understand and read and are not used to limit the limitations that can be implemented in this application. Therefore, there is no technical substantive significance. Any modification of the structure, change in the proportional relationship, or adjustment of the size should still fall within the scope of the technical content disclosed in this application without affecting the efficacy that can be produced by this application and the purpose that can be achieved.

FIG. 1 is a schematic diagram of a three-dimensional structure of a rolling gate provided by the present application;

FIG. 2 is a schematic diagram of a three-dimensional structure of a solar panel provided by the present application;

FIG. 3 is a three-dimensional view of the explosion of the rolling gate provided in this application;

FIG. 4 is a three-dimensional view of the solar panel explosion provided in this application; In the figures: 1 rolling gate, 2 aluminum alloy housing, 3 solar panel, 4 battery, 5 motor, 6 center rotating shaft, 7 control bin rear cover, 8 ultrasonic horns, 9 PCB main board, 10 control bin housing, 11 display screen, 12 flashlight lens, 13 infrared sensor cover, 14 function button PVC sheet, 15 right reel gate guide bracket, 16 left reel gate guide bracket, 17 aluminum strip, 18 solar panel housing, 19 solar panel bottom cover, 20 ground socket swing adjustment part, 21 ground plug tip parts, 22 connecting body DC head interface lines, 23 ground insertion middle part, 24 battery bin housing, 25 battery bin cover, 26 motor bin housing, 27 motor bin cover, 28 clamping gate steel bar, 29 roll gate guide screws.

### DETAILED DESCRIPTION OF THE EMBODIMENT'S

Preferred embodiments of the present application are described below in conjunction with the attached drawings, and it is to be understood that the preferred embodiments described herein are for illustrative and explanatory purposes only and are not intended to limit the present application.

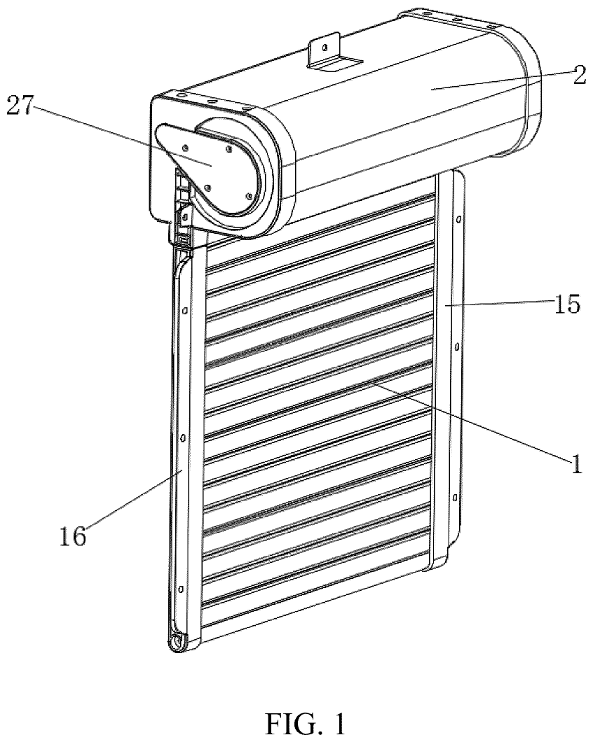

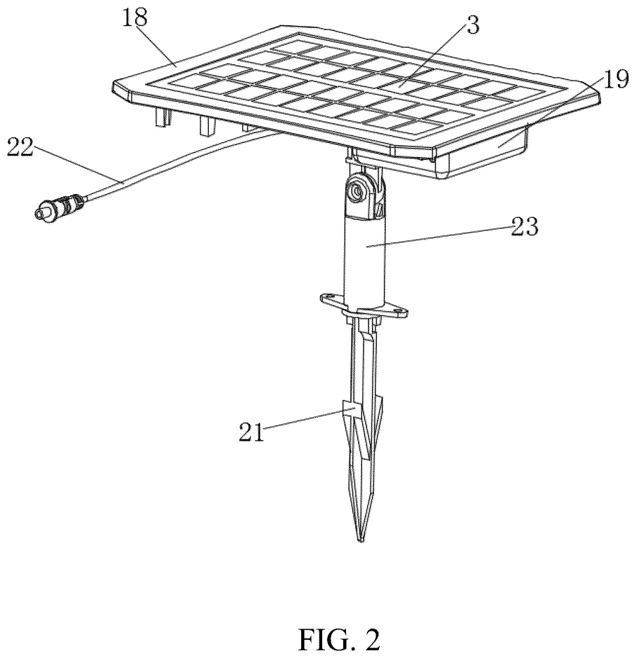

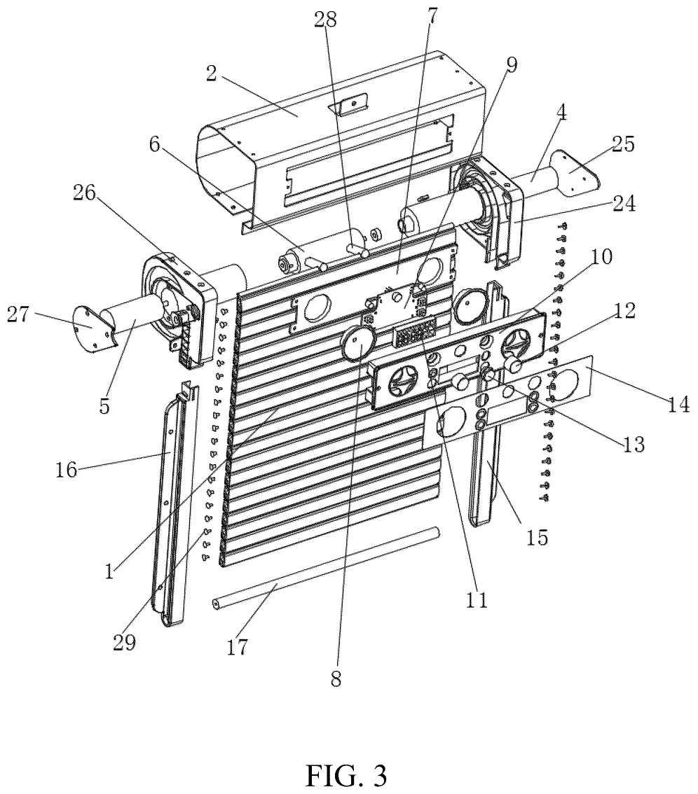

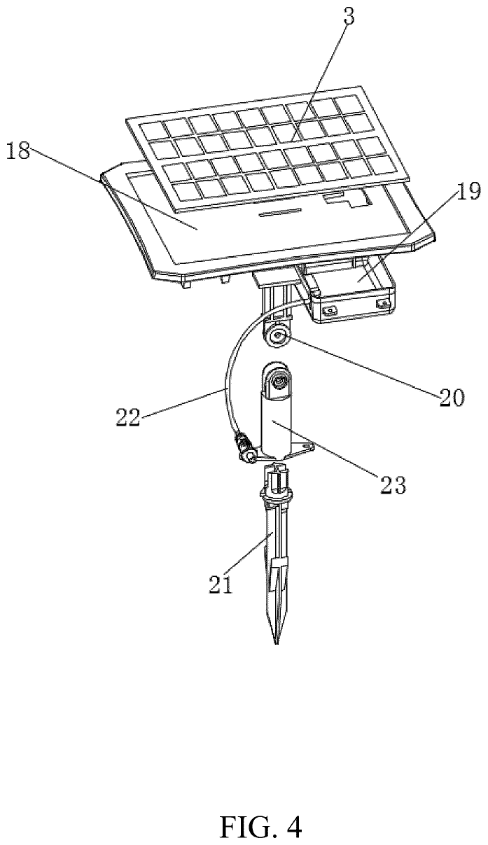

Referring to FIGS. 1-4, Solar-powered Chicken Coop Door provided by the present application, comprises
Rolling gate 1. Rolling gate 1 is provided with an aluminum alloy housing 2 at the top of the rolling gate 1;
Solar panel 3 is provided with a solar panel housing 18 at the bottom of the solar panel 3, and the solar panel 3 is used to provide energy for the switch of the rolling gate 1;
Battery 4, battery 4 is arranged on the inner side of aluminum alloy housing 2, battery compartment housing 24 is arranged on the outer side of battery 4, and battery compartment cover 25 is arranged on the side of battery compartment housing 24;
Motor 5. The motor 5 is arranged on the other side of the aluminum alloy casing 2, the motor casing 26 is arranged on the outside of the motor 5, and the motor casing cover 27 is arranged on one side of the motor casing 26;
In this embodiment, two ultrasonic horns 8 and two flashing lights can drive away the cats, dogs, mice, and other animals lurking nearby after the chicks return to the cage, which can effectively protect the chicks from harm. This ultrasonic wave is harmless to humans;
Among them, in order to achieve the purpose of the gate switch, the device is realized by the following technical solution: the aluminum alloy housing 2 is embedded with a central rotation shaft 6, the front side of the central rotation shaft 6 is equipped with a clamping gate steel bar 28, the bottom of the rolling gate 1 is equipped with an aluminum bar 17, the aluminum bar 17 is arranged between the right rolling gate guide bracket 15 and the left rolling gate guide bracket 16, The bottom of the solar panel housing 18 is provided with a solar panel bottom cover 19, the bottom of the solar panel housing 18 is provided with a ground socket swing adjustment part 20, the bottom of the ground socket swing adjustment part 20 is provided with a ground insertion middle part 23, the bottom of the ground insertion middle part 23 is provided with a ground insertion tip part 21, the side of the solar panel bottom cover 19 is provided with a DC head interface cable 22 connecting the main body, a rolling gate guide rail Screw 29 is installed on both sides of the rolling gate to facilitate the up and down lifting of the rolling gate to prevent the card gate;
Through the work of the motor 5, the motor 5 works to drive the center rotation shaft 6 and the clamping gate steel bar 28 to rotate, thereby driving the rolling gate 1 to rotate, thereby opening and closing the rolling gate 1;
Among them, in order to achieve the purpose of driving animals, the device adopts the following technical solutions: the aluminum alloy casing 2 is embedded with the back cover 7 of the control bin, the front side of the back cover 7 of the control bin is equipped with the PCB motherboard 9, the back cover 7 of the control bin is embedded with two ultrasonic horns 8, two ultrasonic horns 8 are set on both sides of the PCB motherboard 9, the front side of the cover 7 is provided with a control bin housing 10, the inside of the control bin housing 10 is provided with a display screen 11, the display screen 11 is provided on the front side of the PCB motherboard 9 and connected to the PCB motherboard 9, the inside of the control bin housing 10 is provided with a flashlight lens 12 and an infrared sensing cover 13, the flashlight lens 12 and an infrared sensing cover 13 are provided on the top of the display screen 11, the front side of the control cabinet housing 10 is provided with a function key PVC sheet 14;
Through the solar panel 3, it is possible to store power to the battery 4 during the day, without charging it with other power sources. The battery 4 supplies power to the flashlight and the infrared sensor cover 13. The front end of the product senses whether there are animals such as cats and dogs around. When these animals are sensed, the front end of the product will control the flashlight, and the infrared sensor cover 13 to work. After the chick returns to the cage, it can drive away the cats, dogs, mice, and other animals lurking nearby that are sensitive to ultrasound and light, which can effectively protect chicks from harm. This ultrasound is harmless to humans.

The use process of this application is as follows: through the work of the motor 5, the motor 5 works to drive the center rotation shaft 6 and the clamping gate steel bar 28 to rotate, thereby driving the rolling gate 1 to rotate, thereby opening and closing the rolling gate 1. Through the solar panel 3, the battery 4 can store power during the day, without charging with other power sources. The battery 4 supplies power to the flashlight and the infrared sensor cover 13. The front end of the product senses whether there are animals such as cats and dogs around. When these animals are sensed, the front end of the product will control the flashlight, and the infrared sensor cover 13 to work. After the chicken returns to the cage, it can drive away the cats, dogs, mice, other animals that are lurking nearby and are sensitive to light, which can effectively protect the chicken from harm. This ultrasonic wave is harmless to humans.

The above is only a preferred embodiment of the present application, and any person skilled in this art may modify or modify the present application to an equivalent technical solution using the technical solutions described above. Therefore, any simple modification or equivalent substitution made in accordance with the technical solution of this application falls within the scope of this application.

1. Solar-powered Chicken Coop Door, is characterized in that it comprises:
Rolling gate (1), the rolling gate (1) being provided with an aluminum alloy housing (2) at the top;
Solar panel (3), the bottom of the solar panel (3) is provided with a solar panel housing (18), the solar panel (3) is used to provide energy for the switch of the rolling gate (1);
Battery (4), the battery (4) is disposed on the inner side of the aluminum alloy housing (2), a battery compartment housing (24) is disposed on the outer side of the battery (4), and a battery compartment cover (25) is disposed on the one side of the battery compartment housing (24);
Motor (5), the motor (5) is provided on the other side of the aluminum alloy housing (2), the motor (5) is provided with a motor compartment housing (26) on the outside, and the motor compartment cover (27) is provided on one side of the motor compartment housing (26).

2. Solar-powered Chicken Coop Door according to claim 1, is characterized in that the aluminum alloy shell (2) is internally embedded with a central rotation shaft (6), and the front side of the central rotation shaft (6) is provided with a clamping gate steel bar (28).

3. Solar-powered Chicken Coop Door according to claim 1, is characterized in that: the aluminum alloy shell (2) is internally embedded with a control bin rear cover (7), the front side of the control bin rear cover (7) is provided with a PCB main board (9), the control bin rear cover (7) is internally embedded with two ultrasonic horns (8), two ultrasonic horns (8) are respectively arranged on both sides of the PCB motherboard (9).

4. Solar-powered Chicken Coop Door according to claim 3, is characterized in that: the front side of the control bin rear cover (7) is provided with a control bin housing (10), the control bin housing (10) is internally embedded with a display screen (11), the display screen (11) is arranged on the front side of the PCB motherboard (9) and is connected with the PCB motherboard (9).

5. Solar-powered Chicken Coop Door according to claim 4, is characterized in that: the control bin housing (10) is internally embedded with a flashlight lens (12) and an infrared induction cover (13), the flashlight lens (12) and the infrared induction cover (13) are arranged on the top of the display screen (11), and the front side of the control bin housing (10) is provided with a functional key PVC sheet (14).

6. Solar-powered Chicken Coop Door according to claim 1, is characterized in that the motor compartment housing (26) and the bottom of the battery compartment housing (24) are both provided with a right rolling gate guide rail bracket (15) and a left rolling gate guide rail bracket (16).

7. Solar-powered Chicken Coop Door according to claim 1, is characterized in that: the bottom of the rolling gate (1) is provided with an aluminum strip (17), the aluminum strip (17) is provided between the right rolling gate guide bracket (15) and the left rolling gate guide bracket (16).

8. Solar-powered Chicken Coop Door according to claim 1, is characterized in that: the bottom of the solar panel housing (18) is provided with a solar panel bottom cover (19), and the bottom of the solar panel housing (18) is provided with a ground socket swing adjustment part (20).

9. Solar-powered Chicken Coop Door according to claim 8, is characterized in that: the bottom of the ground socket swing adjustment part (20) is provided with a ground insertion middle part (23), and the bottom of the ground insertion middle part (23) is provided with a ground insertion tip part (21).

10. Solar-powered Chicken Coop Door, according to claim 8, is characterized in that one side of the solar panel bottom cover (19) is provided with a DC head interface line (22) connecting the main body.
